(19) United States
(12) Patent Application Publication
(10) Pub. No.: US 2015/0060639 A1
(43) Pub. Date: Mar. 5, 2015

(54) Mold for Food

(71) Applicant: Samsung SDI Co., Ltd., Yongin-si (KR)

(72) Inventors: Young Bae LEE, Uiwang-si (KR); Jae Kyung KIM, Uiwang-si (KR)

(21) Appl. No.: 14/471,326

(22) Filed: Aug. 28, 2014

(30) Foreign Application Priority Data
Sep. 5, 2013 (KR) 10-2013-0106815
Jul. 14, 2014 (KR) 10-2014-0088608

(51) Int. Cl. B29C 33/38

(52) U.S. Cl. CPC B29C 33/3807; B29K 2901/12; B29K 2905/00
USPC 249/117

(57) ABSTRACT

A mold for food includes a thermoplastic resin, a magnetic material, and an impact modifier. The mold for food and fragments thereof can be detected in response to magnetism, and the mold for food can exhibit excellent impact resistance and the like.

### CROSS-REFERENCE TO RELATED APPLICATION

This application claims priority under 35 USC Section 119 to and the benefit of Korean Patent Application No. 10-2013-0106815, filed Sep. 5, 2013, and Korean Patent Application No. 10-2014-0088608, filed Jul. 14, 2014, the entire disclosure of each of which is incorporated herein by reference.

### FIELD OF THE INVENTION

The present invention relates to a forming mold, and more particularly, to a mold for food.

### BACKGROUND

Thermoplastic resins exhibit excellent physical properties such as low specific gravity, good moldability, and good impact resistance, as compared with glass or metal. With the trend of producing low cost, larger and lighter weight molding articles, plastic products made of thermoplastic resins are quickly replacing existing glass and metallic products.

Among the thermoplastic resins, a polycarbonate resin is a representative thermoplastic material having a heat deformation temperature of 135° C. or more and is widely used in various fields due to excellent dimensional stability and heat resistance thereof.

A thermoplastic resin composition including a polycarbonate resin and the like is also used for molding articles, such as chocolate molds and the like. When a product is manufactured using such a mold, the product is separated from the mold by applying impact and/or heat to the mold. However, although the thermoplastic resin used in the mold can exhibit excellent mechanical properties such as impact resistance, heat resistance and the like, the product can contain mold fragments (pieces generated due to breakage of the thermoplastic resin composition) and the like since the mold can be broken by impact or heat during separation of the product from the mold. In particular, when the product is a food, since the mold fragments contained in the food can provide a harmful influence on persons, the mold fragments must be removed from the food.

Therefore, it there is a need for a mold for food, which does not generate such mold fragments through sufficient improvement in properties of the thermoplastic resin composition, such as impact resistance, heat resistance and the like, and can allow detection and removal of the mold fragments even when such mold fragments are formed.

### SUMMARY

Exemplary embodiments of the present invention provide a mold for food, which can allow detection of mold fragments based on magnetic properties through introduction of a magnetic material and can exhibit excellent impact resistance, heat resistance and processability.

The mold for food includes: a thermoplastic resin; a magnetic material; and an impact modifier.

In one embodiment, the thermoplastic resin may include at least one of polycarbonate, aromatic vinyl, polyester, polyphenylene ether, polyamide, and polyolefin resins.

In one embodiment, the magnetic material may include at least one of strontium-ferrite (Sr—Fe₁₂O₁₉), barium-ferrite (Ba—Fe₁₂O₁₉), magnetite (Fe₃O₄), maghemite (γ-Fe₂O₃), nickel-ferrite (Ni—Fe₂O₄), and cobalt-ferrite (Co—Fe2O₄).

In one embodiment, the magnetic material may have a saturation magnetization of about 40 emu/g or more.

In one embodiment, the impact modifier may include at least one of a core-shell graft impact modifier and a branched graft impact modifier. In one embodiment, the core-shell graft impact modifier may be prepared by grafting an aromatic vinyl monomer and at least one monomer copolymerizable with the aromatic vinyl monomer to a rubbery polymer core.

In one embodiment, the branched graft impact modifier may include at least one of methyl methacrylate-butadiene-styrene (MBS), styrene-butadiene-styrene (SBS), styrene-butadiene rubber (SBR), ethylene-propylene rubber (EPM, EPR), ethylene-propylene-diene monomer (EPDM) terpolymer, maleic anhydride-grafted EPDM (EPR-g-MA), maleic anhydride-grafted SBS (SBS-g-MA), maleic anhydride-grafted EPDM (EPDM-g-MA), ethylene methyl acrylate (EMA), ethylene ethyl acrylate (EEA), ethylene vinyl alcohol (EVOH), thermoplastic elastomers, and thermoplastic plastomers.

In one embodiment, the mold for food may include: about 100 parts by weight of the thermoplastic resin; about 3 parts by weight to about 20 parts by weight of the magnetic material; and about 1.5 parts by weight to about 10 parts by weight of the impact modifier.

In one embodiment, the mold for food may have a saturation magnetization of about 1 emu/g or more, as measured on a specimen having a size of about 4 mm×about 4 mm×about 2.5 mm.

In one embodiment, the mold for food may have an Izod impact strength from about 50 kgf·cm/cm to about 90 kgf·cm/cm, as measured on an about ⅛″ thick specimen in accordance with ASTM D256.

In one embodiment, the mold for food may have a melt flow index (MI) from about 5 g/10 min to about 15 g/10 min, as measured at about 220° C. under a load of about 10 kgf in accordance with ASTM D1238.

In one embodiment, the mold for food may include a recess and a frame surrounding the recess.

In one embodiment, the frame may have a width and a length which each independently range from about 10 cm to about 200 cm, and the recess may have a thickness from about 2 cm to about 50 cm.

### BRIEF DESCRIPTION OF THE DRAWINGS

FIG. 1 is a perspective view of a mold for food according to one embodiment of the present invention.

### DETAILED DESCRIPTION

Exemplary embodiments now will be described more fully hereinafter in the following detailed description with reference to the accompanying drawing, in which some, but not all embodiments of the invention are described. Indeed, this invention may be embodied in many different forms and should not be construed as limited to the embodiments set forth herein; rather, these embodiments are provided so that this disclosure will satisfy applicable legal requirements. In the drawing, the dimensions of may be exaggerated for clarity of illustration. Like reference numerals refer to like elements throughout.

According to one embodiment of the present invention, a mold for food includes (A) a thermoplastic resin, (B) a magnetic material, and (C) an impact modifier.

(A) Thermoplastic Resin

According to the present invention, the (A) thermoplastic resin may be any typical thermoplastic resin without limitation. Examples of the thermoplastic resin may include without limitation polycarbonate resins, aromatic vinyl resins, polyester resins, polyphenylene ether resins, polyamide resins, polyolefin resins, and the like. These resins may be used alone or in combination thereof. For example, a polycarbonate resin and an aromatic vinyl resin may be used alone or in combination thereof.

In one embodiment, the polycarbonate resin may be any typical thermoplastic polycarbonate resin without limitation. For example, the polycarbonate resin may be an aromatic polycarbonate resin prepared by reacting one or more diphenols represented by Formula 1 with phosgene, halogen formate, and/or carbonic acid diester.

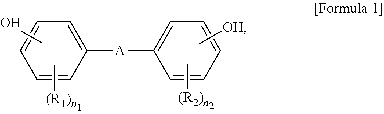

wherein A is a single bond, substituted or unsubstituted C₁ to C₅ alkylene, substituted or unsubstituted C₂ to C₅ alkylidene, substituted or unsubstituted C₃ to C₆ cycloalkylene, substituted or unsubstituted C₅ to C₆ cycloalkylidene, —CO—, —S—, or —SO₂—; Rt and R2 are the same or different and are each independently substituted or unsubstituted C₁ to C₃₀ alkyl or substituted or unsubstituted C₆ to C₃₀ aryl; and n₁ and n₂ are the same or different and are each independently an integer from 0 to 4.

As used herein, the term “substituted” means that a hydrogen atom is substituted with a substituent. Examples of the substituents can include without limitation C₁ to C₃₀ alkyl, C₁ to C₃₀ haloalkyl, C₆ C₃₀ aryl, C₂ to C₃₀ heteroaryl, C₁ to C₂₀ alkoxy, and the like and combinations thereof. As used herein, the term “hetero” refers to one or more of N, O, S, and/or P atoms, in place of a carbon atom.

Examples of diphenols may include without limitation 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, and the like, and combinations thereof. In exemplary embodiments, the diphenol can include 2,2-bis(4-hydroxyphenyl)propane, 2,2-bis(3,5-dichloro-4-hydroxyphenyl)propane, 1,1-bis(4-hydroxyphenyl)cyclohexane, and the like, and combinations thereof. For example, the diphenol can include 2,2-bis(4-hydroxyphenyl)propane, which is also referred to as bisphenol-A.

The polycarbonate resin may be a branched polycarbonate resin, which may be prepared by reacting one or more diphenols with about 0.05 mol % to about 2 mol % of a polyfunctional compound containing tri- or higher functional groups, for example, tri or higher-valent phenol groups, based on the total amount of diphenols used in polymerization.

The polycarbonate resin may be used in the form of a homo-polycarbonate resin, a co-polycarbonate resin, or blends thereof.

In addition, the polycarbonate resin may be partially or completely replaced by an aromatic polyester-carbonate resin obtained by polymerization in the presence of an ester precursor, for example, a bifunctional carboxylic acid.

The polycarbonate resin may have a weight average molecular weight (Mw) from about 10,000 g/mol to about 200,000 g/mol, for example, about 15,000 g/mol to about 80,000, without being limited thereto.

The polycarbonate resin may have a melt flow index (MI) from about 5 g/10 min to about 50 g/10 min, for example, from about 10 g/10 min to about 40 g/10 min, as measured at 300° C. under a load of 1.2 kg in accordance with ISO 1133. The polycarbonate resin may be a mixture of at least two polycarbonate resins having different melt flow indices.

In one embodiment, the aromatic vinyl resin may be a polymer of one or more aromatic vinyl monomers (an aromatic vinyl polymer resin), or a copolymer of an aromatic vinyl monomer and another monomer copolymerizable with the aromatic vinyl monomer (an aromatic vinyl copolymer).

Examples of the aromatic vinyl monomer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and combinations thereof. In exemplary embodiments, the aromatic vinyl monomer may include styrene.

In addition, examples of the monomer copolymerizable with the aromatic vinyl monomer may include an unsaturated nitrile compound, such as acrylonitrile, methacrylonitrile, ethacrylonitrile, and the like, acrylic acid, methacrylic acid, maleic anhydride, and N-substituted maleimide, without being limited thereto. These monomers may be used alone or in combination thereof.

In the aromatic vinyl copolymer, the aromatic vinyl monomer may be present in an amount of about 50 wt % to about 95 wt %, for example, about 60 wt % to about 90 wt %, and as another example about 70 wt % to about 80 wt %, based on the total weight of the aromatic vinyl copolymer. Within this range, the mold for food can exhibit excellent impact strength.

Examples of the aromatic vinyl resin may include polystyrene (PS), high-impact polystyrene (HIPS), a styrene-acrylonitrile copolymer (SAN), an acrylonitrile-styrene-acrylate copolymer (ASA), and the like. These resins may be used alone or in combination thereof.

A method for preparing the aromatic vinyl resin is well known to those skilled in the art, and the resin can be commercially obtained. For example, the aromatic vinyl resin may be polymerized by thermal polymerization without an initiator, or may be polymerized in the presence of the initiator. The polymerization initiator may include at least one of peroxide initiators such as benzoyl peroxide, t-butyl hydroperoxide, acetyl peroxide, cumene hydroperoxide, and the like, and azo initiators such as azobisisobutyronitrile, without being limited thereto.

The aromatic vinyl resin may be prepared by mass polymerization, suspension polymerization, emulsion polymerization, or combinations thereof For example, mass polymerization can be used.

The aromatic vinyl resin may have a weight average molecular weight of about 10,000 g/mol to about 500,000 g/mol as measured by gel permeation chromatography (GPC), without being limited thereto.

When the (A) thermoplastic resin according to the present invention is a mixture of the polycarbonate resin and the aromatic vinyl resin, the polycarbonate resin may be present in an amount of about 10 wt % to about 99 wt %, for example, about 20 wt % to about 85 wt %, and the aromatic vinyl resin may be present in an amount of about 1 wt % to about 90 wt %, for example, about 15 wt % to about 80 wt %, based on the total weight (100 wt %) of the mixture.

In some embodiments, the mixture of the polycarbonate resin and the aromatic vinyl resin may include the polycarbonate resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %. Further, according to some embodiments of the present invention, the amount of polycarbonate resin can be in a range from about any of the foregoing amounts to about any other of the foregoing amounts.

In some embodiments, the mixture of the polycarbonate resin and the aromatic vinyl resin may include the aromatic vinyl resin in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the amount of aromatic vinyl resin can be in a range from about any of the foregoing amounts to about any other of the foregoing amounts.

Within this range, the mold for food can exhibit excellent properties in terms of impact strength, processability, heat resistance, and the like.

(B) Magnetic Material

According to the present invention, the magnetic material is included in the mold for food such that the mold and fragments thereof can be detected in response to magnetism. The magnetic material is a material capable of being magnetized by a magnetic field. For example, the magnetic material may include without limitation: transition metals such as iron, manganese, chromium, nickel, cobalt, zinc, and the like; transition metal compounds such as oxides, sulfides, phosphides and alloys thereof, oxides, sulfides and phosphides of alloys thereof, and the like; and compositions including these materials. Examples of the magnetic material may include without limitation strontium-ferrite (Sr—Fe₁₂O₁₉), barium-ferrite (Ba—Fe₁₂O₁₉), magnetite (Fe₃O₄), maghemite (γ-Fe₂O₃), nickel-ferrite (Ni—Fe₂O₄), cobalt-ferrite (Co—Fe₂O₄), and the like, and mixtures thereof In exemplary embodiments, the magnetic material may be magnetite (Fe₃O₄).

In exemplary embodiments, the magnetic material may have various forms, such as but not limited to particles, powders and the like, and combinations thereof, and may have an average size (particle diameter, and the like) from about 1 nm to about 1,500 nm, for example, from about 200 nm to about 1,000 nm, as another example from about 500 nm to about 900 nm, and as other examples about 500 nm, about 550 nm, about 600 nm, about 650 nm, about 700 nm, about 750 nm, about 800 nm, about 850 nm, and/or 900 nm. Within this range, the magnetic material can be uniformly dispersed in the mold, and a specimen (fragment) of the mold for food having a size of a few millimeters or less can be detected by a magnetic detector.

In one embodiment, the magnetic material may have a magnetic intensity (saturation magnetization, Ms) of about 40 emu/g or more, for example, from about 40 emu/g to about 100 emu/g. Within this range, a specimen (fragment) of the mold for food having a size of a few millimeters or less can be detected by a magnetic detector.

In one embodiment, the magnetic material may be present in an amount of about 3 parts by weight to about 20 parts by weight, for example, about 5 parts by weight to about 10 parts by weight, and as another example about 5 parts by weight, about 6 parts by weight, about 7 parts by weight, about 8 parts by weight, about 9 parts by weight, or about 10 parts by weight, based on about 100 parts by weight of the thermoplastic resin. In some embodiments, the magnetic material may be present in an amount of about 3, 4, 5, 6, 7, 8, 9, 10, 11, 12, 13, 14, 15, 16, 17, 18, 19, or 20 parts by weight. Further, according to some embodiments of the present invention, the amount of magnetic material can be in a range from about any of the foregoing amounts to about any other of the foregoing amounts.

Within this range, the mold for food and fragments thereof can be detected by a magnetic detector, and the mold for food can exhibit excellent properties in terms of impact resistance, heat resistance, processability and the like, and have a good balance therebetween.

(C) Impact Modifier

According to the present invention, the impact modifier may be any typical impact modifier without limitation. Examples of the impact modifier may include without limitation core-shell graft impact modifiers, branched graft impact modifiers, and the like, and mixtures thereof.

In one embodiment, the core-shell graft impact modifier may be obtained by grafting an unsaturated compound including an aromatic vinyl monomer and optionally at least one monomer copolymerizable with the aromatic vinyl monomer to a rubbery polymer core.

Examples of the rubbery polymer (core) may include without limitation: diene rubbers such as polybutadiene, poly(styrene-butadiene), poly(acrylonitrile-butadiene), and the like; saturated rubbers obtained by adding hydrogen to the diene rubbers; isoprene rubbers; acrylic rubbers such as poly(butyl acrylate); ethylene-propylene-diene monomer (EPDM) terpolymers, and the like, and combinations thereof In exemplary embodiments, the rubbery polymer is a diene rubber, for example a butadiene rubber.

The core-shell impact modifier may include the rubbery polymer in an amount of about 5 wt % to about 65 wt %, for example, about 10 wt % to about 60 wt %, and as another example about 20 wt % to about 50 wt %, based on the total weight of the core-shell graft impact modifier (core-shell graft copolymer). Within this range, the mold for food can exhibit excellent impact strength.

The rubbery polymer (rubbery particles) may have an average (z-average) particle size from about 0.05 μm to about 6 μm, for example, from about 0.15 μm to about 4 μm, and as another example form about 0.25 μm to about 3.5 μm. Within this range, the mold for food can exhibit excellent impact strength and appearance.

The aromatic vinyl monomer may be an aromatic vinyl monomer capable of being grafted to the rubbery copolymer. Examples of the aromatic vinyl monomer capable of being grafted to the rubbery copolymer may include without limitation styrene, α-methylstyrene, β-methylstyrene, p-methylstyrene, p-t-butylstyrene, ethylstyrene, vinylxylene, monochlorostyrene, dichlorostyrene, dibromostyrene, vinyl naphthalene, and the like, and combinations thereof. In exemplary embodiments, the aromatic vinyl monomer is styrene.

Examples of the monomer copolymerizable with the aromatic vinyl monomer may include without limitation an unsaturated nitrile compound such as acrylonitrile, methacrylonitrile, ethacrylonitrile and the like, acrylic acid, methacrylic acid, maleic anhydride, N-substituted maleimide, and the like. These monomers may be used alone or in combination thereof.

The core-shell impact modifier may include the unsaturated compound in an amount of about 35 wt % to about 95 wt %, for example, about 40 wt % to about 90 wt %, and as another example about 50 wt % to about 80 wt %, based on the total weight of the core-shell graft impact modifier. In addition, when the unsaturated compound is a mixture of the aromatic vinyl monomer and the monomer copolymerizable with the aromatic vinyl monomer, the aromatic vinyl monomer may be present in an amount of about 50 wt % to about 95 wt %, for example, about 60 wt % to about 90 wt %, and the monomer copolymerizable with the aromatic vinyl monomer may be present in an amount of about 5 wt % to about 50 wt %, for example, about 10 wt % to about 40 wt %, based on the total weight of the unsaturated compound. Within this range, the mold for food can exhibit excellent impact strength.

Examples of the core-shell graft impact modifier may include a copolymer (g-ABS) in which a styrene monomer corresponding to an aromatic vinyl compound and an acrylonitrile monomer corresponding to an unsaturated nitrile compound are grafted to a core butadiene rubbery polymer and thus form a shell, without being limited thereto.

In one embodiment, the branched graft impact modifier may include without limitation methyl methacrylate-butadiene-styrene (MBS), styrene-butadiene-styrene (SBS), styrene-butadiene rubber (SBR), ethylene-propylene rubber (EPM, EPR), ethylene-propylene-diene monomer (EPDM) terpolymer, maleic anhydride-grafted EPDM (EPR-g-MA), maleic anhydride-grafted SBS (SBS-g-MA), maleic anhydride-grafted EPDM (EPDM-g-MA), ethylene methyl acrylate (EMA), ethylene ethyl acrylate (EEA), ethylene vinyl alcohol (EVOH), thermoplastic elastomers, thermoplastic plastomers, and the like, and mixtures thereof. For example, the branched graft impact modifier may include methyl methacrylate-butadiene-styrene (MBS), styrene-butadiene-styrene (SBS), styrene-butadiene rubber (SBR), and the like, and combinations thereof.

In one embodiment, the impact modifier may be present in an amount of about 1.5 parts by weight to about 10 parts by weight, for example, about 1.5 parts by weight to about 2 parts by weight, and as another example about 1.5 parts by weight, about 1.6 parts by weight, about 1.7 parts by weight, about 1.8 parts by weight, about 1.9 parts by weight, or about 2.0 parts by weight, based on about 100 parts by weight of the thermoplastic resin. In some embodiments, the impact modifier may be present in an amount of about 1.5, 2, 2.5, 3, 3.5, 4, 4.5, 5, 5.5, 6, 6.5, 7, 7.5, 8, 8.5, 9, 9.5, or 10 parts by weight. Further, according to some embodiments of the present invention, the amount of impact modifier can be in a range from about any of the foregoing amounts to about any other of the foregoing amounts.

Within this range, the mold for food can exhibit excellent properties in terms of impact resistance, heat resistance, processability and the like, and have good balance therebetween.

According to the present invention, the mold for food may further include one or more typical additives, as needed. Examples of the additives include without limitation flame retardants, antioxidants, nucleating agents, surfactants, coupling agents, fillers, plasticizers, lubricants, antimicrobials, release agents, heat stabilizers, photostabilizers, compatibilizers, inorganic additives, colorants, stabilizers, antistatic agents, pigments, dyes, flame-proofing agents, and the like. These additives may be used alone or in combination thereof.

When the additives are used, the additives may be present in an amount of about 0.01 parts by weight to about 40 parts by weight based on about 100 parts by weight of the thermoplastic resin, without being limited thereto.

In one embodiment, the mold for food may be prepared through various molding methods, such as injection molding, extrusion, vacuum molding, casting, and the like, using a thermoplastic resin composition prepared in pellet form by mixing the above components with other additives, followed by melt extrusion in an extruder. The molding methods are well known to those skilled in the art.

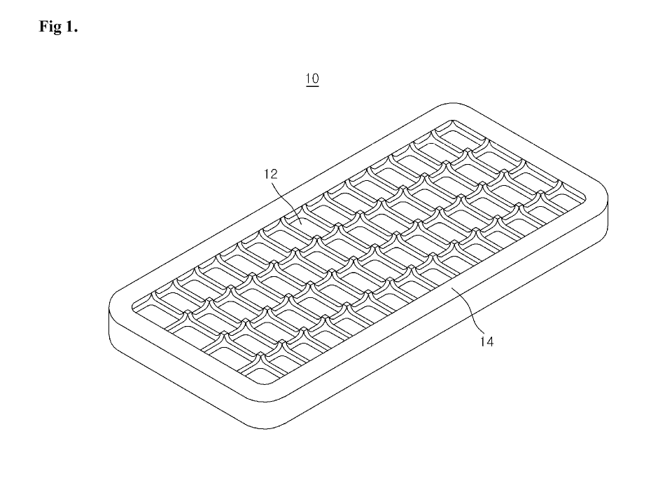

FIG. 1 is a perspective view of a mold for food according to one embodiment of the present invention. As shown in FIG. 1, according to the present invention, a mold for food 10 may include a recess (design portion) 12; and a frame 14 surrounding the recess. The recess 12 can accommodate fluid type food such as liquid chocolates and the like, and allows a desired shape to be transferred to the food. The mold may have a plurality of recesses 12. In one embodiment, a fluid type food such as liquid chocolate and the like is poured into the recess (design portion) 12, followed by curing, thereby preparing a food such as recess-shaped solid chocolates and the like. For example, the frame 14 (mold for food 10) may have a width and a length which each independently range from about 10 cm to about 200 cm, without being limited thereto. In addition, the recess (design portion) 12 may have a size and a shape, which vary with shapes of food to be prepared, and may have a thickness (depth of the recess) from about 2 cm to about 50 cm, without being limited thereto. For example, as shown in FIG. 1, a great quantity of food can be prepared in a rectangular shape using the mold for food including at least one rectangular recess formed therein.

In one embodiment, the mold for food according to the present invention may have a saturation magnetization of about 1 emu/g or more, for example, from about 1 emu/g to about 10 emu/g, as measured on a specimen having a size of about 4 mm×about 4 mm×about 2.5 mm. Within this range, a specimen (fragment) of the mold for food having a size of a few millimeters or less can be detected by a magnetic detector.

The mold for food may have an Izod impact strength from about 50 kgf·cm/cm to about 90 kgf·cm/cm, for example, from about 55 kgf·cm/cm to about 80 kgf·cm/cm, as measured on an about ⅛″ thick specimen in accordance with ASTM D256.

The mold for food may have a Vicat softening temperature (VST) from about 130° C. to about 150° C., for example, from about 135° C. to about 145° C.

In addition, the mold for food may have a melt flow index (MI) from about 5 g/10 min to about 15 g/10 min, for example, from about 7 g/10 min to about 11 g/10 min, as measured at about 220° C. under a load of about 10 kgf in accordance with ASTM D1238.

Since the mold for food according to the present invention can exhibit excellent impact resistance, processability, heat resistance and the like, and can respond to magnetism, the mold for food is particularly useful for chocolate molds and the like, which require detection and removal of mold fragments (pieces) from products (foods).

Hereinafter, the present invention will be described in more detail with reference to the following examples. It should be understood that these examples are provided for illustration only and are not to be construed in any way as limiting the present invention.

### EXAMPLES

Details of components used in Examples and Comparative Examples are as follows:

(A) Thermoplastic Resin

A polycarbonate resin (model: INFINO, Cheil Industries Inc.) is used.

(B) Magnetic Material

Magnetite (Fe₃O₄, model: Bayoxide, Lanxess Co., Ltd. (Germany)) is used.

(C) Impact Modifier

Methylmethacrylate-butadiene-styrene (MBS, model: METABLEN C-223A, KUREHACHIM Co., Ltd.) is used.

### Examples 1 to 3 and Comparative Examples 1 to 2

The components are added in amounts as listed in Table 1, respectively, followed by melting, kneading and extrusion, thereby preparing pellets. Here, extrusion is performed using a twin-screw extruder having L/D=32 and a diameter of 30 mm. The prepared pellets are dried at 80° C. for 6 hours, followed by injection molding in a 3 oz injection machine at 270° C., thereby preparing a specimen of a mold for food (4 mm×4 mm×2.5 mm). Each of the prepared specimens is evaluated as to the following properties. Results are shown in Table 1.

Evaluation of Properties

(1) Izod impact strength (unit: kgf·cm/cm): Izod impact strength is measured on a ⅛″ thick notched Izod specimen in accordance with ASTM D256.

(2) Melt flow index (MI, unit: g/10 min): Melt flow index is measured at 220° C. under a load of 10 kgf in accordance with ASTM D1238.

(3) Magnetic intensity (unit: emu/g): Magnetic intensity is measured using a Vibrating Sample Magnetometer (VSM, LakeShore Co., Ltd.), in which measurement is performed by recording applied magnetic field by a Hall probe (range: −5000˜5,000 Oe), followed by measuring magnetization (unit: emu) of a specimen for the applied magnetic field by recording electromotive force obtained by Faraday's law when vibration is applied to the specimen. Among the magnetizations, the highest magnetization is divided by a weight of the specimen, thereby obtaining magnetic intensity (Ms, unit: emu/g).

TABLE 1

| | Example | | | Comparative Example | |
|---|---|---|---|---|---|
| | 1 | 2 | 3 | 1 | 2 |
| (A) (parts | 100 | 100 | 100 | 100 | 100 |
| by weight) | | | | | |
| (B) (parts | 5 | 5 | 7 | — | 5 |
| by weight) | | | | | |
| (C) (parts | 1.0 | 1.5 | 1.0 | — | — |
| by weight) | | | | | |
| Izod impact | 79.71 | 79.76 | 59.11 | 10 | 8.45 |
| strength | | | | | |
| Melt flow | 7.50 | 7.10 | 8.10 | 8.0 | 10.10 |
| index | | | | | |
| Saturation | 1.1978 | 1.1978 | 1.6599 | 0.0046 | 1.1978 |
| magneti- | | | | | |
| zation | | | | | |

From the results of Table 1, it can be seen that the molds for food according to the present invention (molds for food prepared in Examples 1 to 3) exhibit excellent impact resistance and melt flow index (processability). In addition, it can be seen that, since the molds for food according to the present invention have a saturation magnetization of 1 emu/g or more, even small fragments of the molds having a size of a few millimeters or less can be detected by a magnetism tester.

Conversely, it can be seen that the mold for food of Comparative Example 1 not containing a magnetic material and an impact modifier is not suitable as a mold for food due to low impact strength thereof, and that it is difficult to detect fragments thereof having a size of a few millimeters or less using a magnetism tester due to low saturation magnetization thereof In addition, it can be seen that the mold for food of Comparative Example 2 is not suitable as a mold for food due to low impact strength thereof.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims.

What is claimed is:

1. A mold for food, comprising:
a thermoplastic resin;
a magnetic material; and
an impact modifier.

2. The mold for food according to claim 1, wherein the thermoplastic resin comprises polycarbonate resin, aromatic vinyl resin, polyester resin, polyphenylene ether resin, polyamide resin, polyolefin resin or a combination thereof.

3. The mold for food according to claim 1, wherein the magnetic material comprises strontium-ferrite (Sr—Fe₁₂O₁₉), barium-ferrite (Ba—Fe₁₂O₁₉), magnetite (Fe₃O₄), maghemite (γ-Fe₂O₃), nickel-ferrite (Ni—Fe2O₄), cobalt-ferrite (Co—Fe₂O₄), or a combination thereof.

4. The mold for food according to claim 1, wherein the magnetic material has a saturation magnetization of about 40 emu/g or more.

5. The mold for food according to claim 1, wherein the impact modifier comprises a core-shell graft impact modifier, a branched graft impact modifier, or a combination thereof.

6. The mold for food according to claim 5, wherein the core-shell graft impact modifier is prepared by grafting an aromatic vinyl monomer and at least one monomer copolymerizable with the aromatic vinyl monomer to a rubbery polymer core.

7. The mold for food according to claim 5, wherein the branched graft impact modifier comprises methyl methacrylate-butadiene-styrene (MBS), styrene-butadiene-styrene (SBS), styrene-butadiene rubber (SBR), ethylene-propylene rubber (EPM, EPR), ethylene-propylene-diene monomer (EPDM) terpolymer, maleic anhydride-grafted EPDM (EPR-g-MA), maleic anhydride-grafted SBS (SBS-g-MA), maleic anhydride-grafted EPDM (EPDM-g-MA), ethylene methyl acrylate (EMA), ethylene ethyl acrylate (EEA), ethylene vinyl alcohol (EVOH), thermoplastic elastomer, thermoplastic plastomer, or a combination thereof.

8. The mold for food according to claim 1, wherein the mold for food comprises: about 100 parts by weight of the thermoplastic resin; about 3 parts by weight to about 20 parts by weight of the magnetic material; and about 1.5 parts by weight to about 10 parts by weight of the impact modifier.

9. The mold for food according to claim 1, wherein the mold for food has a saturation magnetization of about 1 emu/g or more, as measured on a specimen having a size of about 4 mm×about 4 mm×about 2.5 mm.

10. The mold for food according to claim 1, wherein the mold for food has an Izod impact strength from about 50 kg·cm/cm to about 90 kgf·cm/cm, as measured on an about ⅛″ thick specimen in accordance with ASTM D256.

11. The mold for food according to claim 1, wherein the mold for food has a melt flow index (MI) from about 5 g/10 min to about 15 g/10 min, as measured at about 220° C. under a load of about 10 kgf in accordance with ASTM D1238.

12. The mold for food according to claim 1, wherein the mold for food comprises: a recess and a frame surrounding the recess.

13. The mold for food according to claim 12, wherein the frame has a width and a length which each independently range from about 10 cm to about 200 cm, and the recess has a thickness from about 2 cm to about 50 cm.
